(19) United States
(12) Patent Application Publication
(10) Pub. No.: US 2008/0162250 A1
(43) Pub. Date: Jul. 3, 2008

(54) Single User Interface Window Event Scheduling

(76) Inventor: Veronica Llanes Carrion, Austin, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(21) Appl. No.: 12/049,320

(22) Filed: Mar. 15, 2008

Related U.S. Application Data
(63) Continuation of application No. 11/086,712, filed on Mar. 22, 2005.

(51) Int. Cl. G06Q 10/00

(52) U.S. Cl. 705/9

(57) ABSTRACT

An approach to handling single user interface window event scheduling is presented. A user sends an event request to a scheduling tool, whereby the scheduling tool provides participant schedules, location schedules, and equipment schedules for the user to easily view in a single user interface window. In turn, the user may reserve a location, reserve equipment, and send invitations to participants using the single user interface window. In one embodiment, a user may prioritize an event whereby the scheduling tool associates an “event priority” with a reservation that is included in a location schedule. In this embodiment, when conflicts arise between a reserved event and a new event, the scheduling tool determines whether the new event has a higher priority than the reserved event. If so, the scheduling tool removes the reserved event from the location schedule and adds the new event to the location schedule.

### RELATED APPLICATIONS

This application is a continuation application of co-pending U.S. Non-Provisional patent application Ser. No. 11/086,712, entitled “System and Method for Single User Interface Window Event Scheduling,” filed on Mar. 22, 2005.

### BACKGROUND OF THE INVENTION

1. Technical Field

The present invention relates in general to a system and method for single user interface window event scheduling. More particularly, the present invention relates to a system and method for a user to schedule an event using a single user interface window that includes participant schedules, location schedules, and equipment schedules.

2. Description of the Related Art

Scheduling an event can be cumbersome and time consuming, especially when scheduling the event involves sending invitations to possible participants, reserving a location, and reserving equipment for the event. Particularly for large events, a user may spend many hours scheduling the event in an effort to identify times at which participants, a location, and equipment are concurrently available.

Existing art allows a user to view participant schedules in a user window, and then select an event time based upon a time that the participants are concurrently available. A challenge found, however, is that a user must open a separate user interface window in order to identify a time at which a location for conducting the event is available. In fact, a user may toggle between a participant invitation window and a location window multiple times before identifying available times that the participants and the location are concurrently available.

In addition, the complexity of scheduling an event increases when a user wishes to reserve equipment, such as a projector, a computer, or a printable whiteboard, for use at the event. In this situation, if the equipment is electronically scheduled, the user must open a third window in order to identify equipment availability. As a result, the user may toggle between three separate user interface windows in order to schedule an event. When the equipment is not electronically scheduled, the user may make several phone calls in order to reserve the equipment, thereby complicating the user's task even more.

Furthermore, when a user cancels an event, the user typically sends cancellation notices to participants, but, however, the user may not cancel his/her location reservation. In turn, another user may not be able to reserve the location at a particular time because the location is still reserved for the cancelled event.

What is needed, therefore, is a system and method to reduce the complexity of scheduling an event and canceling location reservations when their corresponding events are cancelled.

### SUMMARY

It has been discovered that the aforementioned challenges are resolved using a system and method for a user to schedule an event using a single user interface window. A user sends an event request to a scheduling tool, whereby the scheduling tool provides participant schedules, location schedules, and equipment schedules for the user to view in a single user interface window. In turn, the user may reserve a location, reserve equipment, and send invitations to participants using the single user interface window.

A user wishes to schedule an event, and uses his/her client computer to send an event request to a scheduling tool. The event request includes one or more participant identifiers, a location identifier, and may include one or more equipment identifiers. The participant identifiers correspond to participants that are invited to the event. The location identifier corresponds to a location for conducting the event, such as a conference room. And, the equipment identifiers may correspond to equipment such as a projector, a television, a printable white board, or a computer.

The scheduling tool receives the event request, extracts identifiers that are included in the event request, and identifies schedules that correspond to the participant identifiers, the location identifier, and the equipment identifiers. In turn, the scheduling tool retrieves the identified schedules from a schedule storage area, and provides the schedules to the user's client for the user to view. In one embodiment, the scheduling tool provides the schedules to the user's client in a single user interface window while, in another embodiment, the scheduling tool provides the schedules to the user's client, and the user's client includes the schedules in a user interface window.

The user reviews the schedules, and identifies an event time that the participants, the location, and the equipment are available for the event. The user includes the event time in a reservation request, and sends the reservation request to the scheduling tool to process. If there are no conflicts with reserving the location, the scheduling tool reserves the location, reserves the equipment, and sends invitations to the invited participants. The scheduling tool also sends a confirmation to the user who scheduled the event, notifying him/her that the location and equipment has been successfully reserved.

In one embodiment, a user may prioritize an event whereby the scheduling tool associates an “event priority” with a reservation that is included in the location schedule. In this embodiment, when conflicts arise between a reserved time block and a new event, the scheduling tool determines whether the new event has a higher priority than the reserved time block. For example, a new event may have an event time from 2 pm-4 pm on Jan. 31, 2005 and, in this example, the location schedule includes a reserved time block from 1 pm-3 pm, which has a “C” priority. If the new event has a higher priority than the reserved time block, the scheduling tool removes the reserved time block from the location schedule and inserts a new time block into the location schedule. In this embodiment, the scheduling tool may also identify the number of participants in the reserved event corresponding to the removed time block, and provide location alternatives that accommodate the identified number of participants to the originator of the reserved event.

In another embodiment, inanimate objects, such as locations and equipment, are assigned corresponding email addresses, which are used as identifiers. In turn, the scheduling tool may act as a “proxy” for the inanimate objects and automatically respond to a request according to a standard default policy. For example, a scheduling tool may allow a vice-president or his/her assistant to bump anyone from his/her particular conference room schedule in order for the vice-president to use the conference room. In addition, participant email addresses may be used as participant identifiers. Thus, the scheduling tool may act as a proxy for the participants as well. For example, the scheduling tool may retrieve a policy that instructs the scheduling tool to always accept an invitation from a participant's manager.

By using email addresses as identifiers, different scheduling systems may be tied together that support participants, locations, and equipment. For example, event notifications may be sent to participant email addresses, a location email address, and equipment email addresses over the Internet, and a remote scheduler that handles invitations for inanimate objects at remote locations processes the event notification and sends a response to the event notification originator.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing a user scheduling an event;

FIG. 2A is diagram showing a user interface window that includes schedules that correspond to participants, a location, and equipment;

FIG. 2B is diagram showing a user interface window that includes a location schedule with a prioritized time block;

FIG. 3 is high-level flowchart showing steps taken in scheduling or canceling an event;

FIG. 4 is a flowchart showing steps taken in retrieving schedules that correspond to participants, a location, and equipment;

FIG. 5 is a flowchart showing steps taken in reserving a location and sending invitations to participants for an event; and

FIG. 6 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

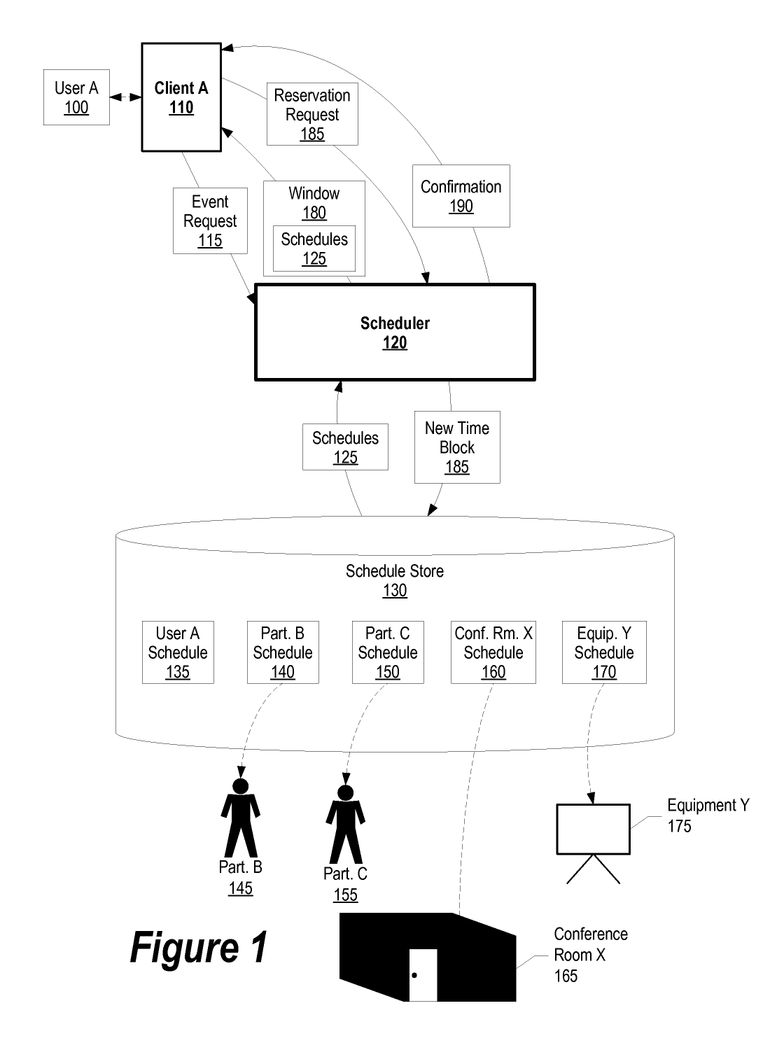

FIG. 1 is a diagram showing a user scheduling an event. User A 100 uses the invention described herein to view participant schedules, location schedules, and equipment schedules in a single user interface window in order to easily identify times at which corresponding participants, a location, and equipment are available.

User A 100 wishes to schedule an event, and uses client A 110 to send event request 115 to scheduler 120. Event request 115 includes one or more participant identifiers, a location identifier, and may include one or more equipment identifiers. The participant identifiers correspond to participants that are invited to the event. The location identifier corresponds to a location for the event, such as a conference room. And, the equipment identifiers may correspond to equipment such as a projector, a television, a printable white board, or a computer.

In one embodiment, locations and equipment are assigned corresponding email addresses. In this embodiment, the participant identifiers, location identifier, and equipment identifiers discussed above are email addresses corresponding to participants, a location, and equipment, respectively.

Scheduler 120 receives event request 115, extracts the identifiers, and determines that the participant identifiers correspond to participant B 145 and participant C 155. Scheduler 120 also determines that the location identifier included in event request 115 corresponds to conference room X 165. Finally, scheduler 120 determines that an equipment identifier that is included in event request 115 corresponds to equipment Y 175. In turn, scheduler 120 retrieves schedules 125 from schedule store 130. Schedules 125 include user A schedule 135 (corresponding to user A 100), participant B schedule 140 (corresponding to participant B 145), participant C schedule 150 (corresponding to participant C 155), conference room X schedule 160 (corresponding to conference room X 165), and equipment Y schedule 170 (corresponding to equipment Y 175).

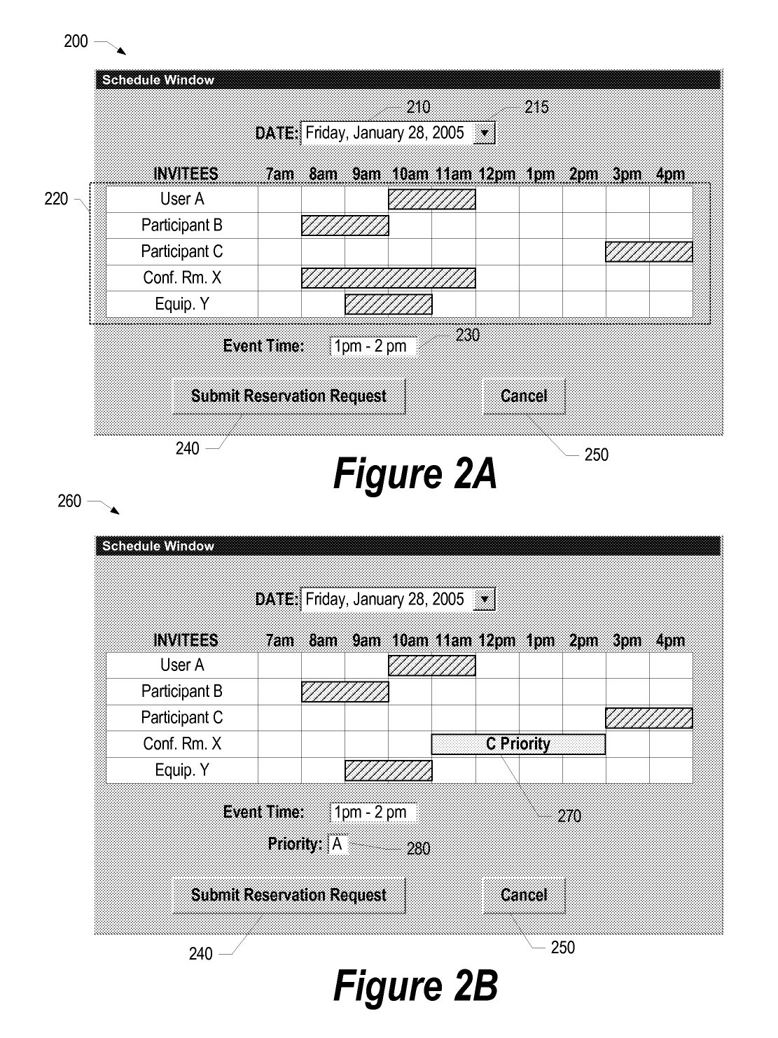

Scheduler 120 provides window 180 that includes schedules 125 to client A 110 for user A 100 to view. Window 180 is a user interface window such as those shown in FIGS. 2A and 2B. In one embodiment, scheduler 120 provides schedules 125 to client A 110, whereby client A 110 includes schedules 125 in a single user interface window.

User A 100 reviews the schedules, and identifies an event time that the participants, the location, and the equipment are available for the event. Client A 110 includes the event time in reservation request 185, and sends reservation request 185 to scheduler 120 to process. If there are no conflicts with reserving the location (i.e. conference room X 165), scheduler 120 reserves conference room X 165 and equipment Y 175 by inserting new time block 185 into conference room X schedule 160 and equipment Y schedule 170, respectively. In addition, scheduler 120 sends confirmation 190 to client A 110 and sends invitations to participant B 145 and participant C 155 (e.g., an email).

In one embodiment, a user may prioritize an event whereby scheduler 120 associates an event priority with a time block that is inserted into a location schedule. In this embodiment, if conflicts arise between a reserved event and a new event, scheduler 120 determines whether the new event has a higher priority than the reserved event. For example, the new event time may be from 2 pm-4 pm on Jan. 31, 2005 and, in this example, the location schedule includes a reserved time block from 1 pm-3 pm, which has an assigned planned time block priority of “C.” If the new event has a higher priority than the reserved time block, scheduler 120 removes the reserved time block and inserts a new time block into conference room X schedule 160. In this embodiment, scheduler 120 may also identify the number of invitees of the reserved event corresponding removed time block, select locations that are able to accommodate the number of invitees, and provide location alternatives to the originator of the reserved event.

In another embodiment, inanimate objects, such as conference room X 165 and equipment Y 175, are assigned corresponding email addresses, which are used as identifiers. In turn, scheduler 120 may act as a “proxy” for the inanimate objects and automatically respond to a request according to a standard default policy. For example, scheduler 120 may allow a vice-president or his/her assistant to bump anyone from his/her particular conference room schedule in order for the vice-president to use the conference room. In addition, participant email addresses may be used as participant identifiers. Thus, scheduler 120 may act as a proxy for the participants as well. For example, scheduler 120 may retrieve a policy that instructs it to always accept an invitation from a participant's manager.

By using email addresses as identifiers, different scheduling systems may be tied together that support participants, locations, and equipment. For example, event notifications may be sent to participant email addresses, a location email address, and equipment email addresses over the Internet, and a remote scheduler that handles invitations for inanimate objects at remote locations processes the event notification and sends a response to the event notification originator.

FIG. 2A is diagram showing a user interface window that includes schedules that correspond to participants, a location, and equipment. Window 200 includes schedule area 220. Schedule area 220 provides a user with a comprehensive view of schedules that correspond to participants, a location, and equipment on a single user interface window.

When a scheduling tool receives an event request, the scheduling tool retrieves schedules corresponding to particular identifiers. In turn, the scheduling tool provides the schedules to a user to view. When the user views window 200, the user is able to select an event date in text field 210. Or, the user may select arrow 215 and select an event date from a pull-down menu. When the user identifies a particular event time that the participants, the location, and the equipment are available, the user enters the event time in text block 230. The example shown in FIG. 2A shows that the user requests an event time from 1 pm-2 pm because, as can be seen in schedule area 220, user A, participant B, participant C, conference room X, and equipment Y are all available between 1 pm and 2 pm.

When the user wishes to send a reservation request to the scheduling tool, the user selects command button 240. If the user wishes to cancel the event request, the user selects command button 250 to close window 200.

FIG. 2B is diagram showing a user interface window that includes a location schedule with a prioritized time block. FIG. 2B is similar to FIG. 2A with the exception that window 260 shows a user interface window for an embodiment that prioritizes events.

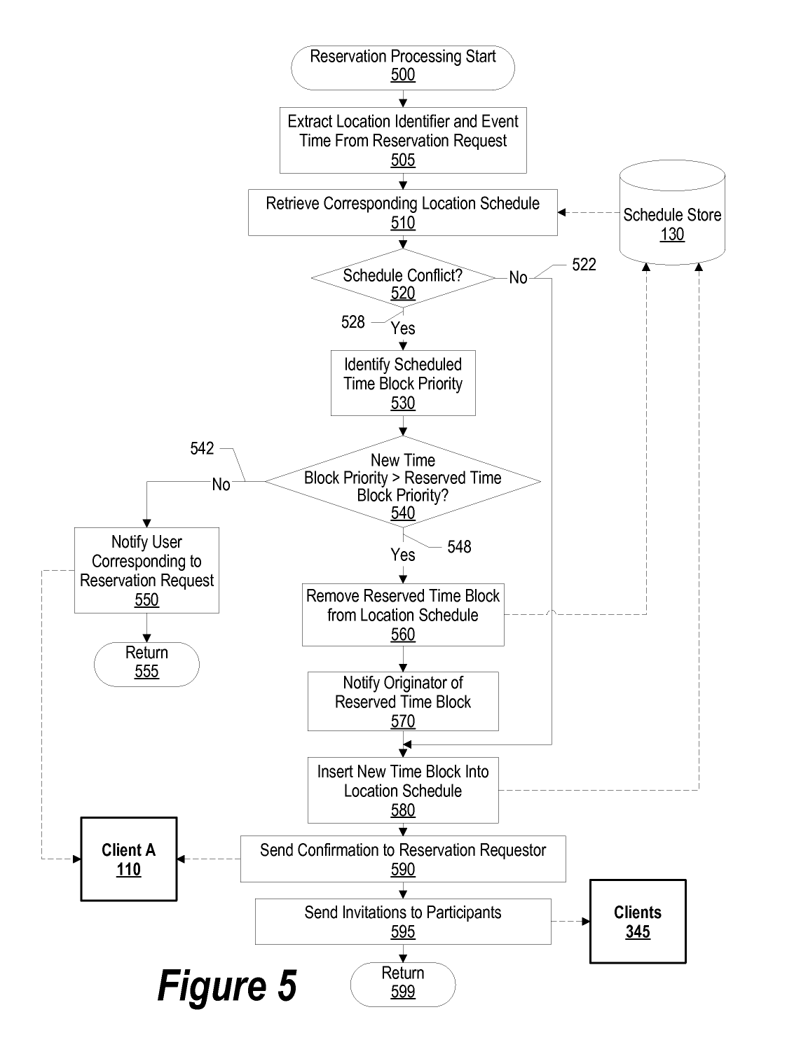

Window 260 shows a prioritized reserved time block, which is time block 270. Time block 270 has a corresponding “C” priority, and a user can view window 260 to determine whether his/her event has a higher priority than a planned event. If so, the user may enter a priority in text box 280, and send a reservation request to the scheduling tool. For example, FIG. 2B shows that the user has entered an “A” priority in text block 280 for an event between 1 pm and 2 pm. Therefore, the scheduling tool will remove time block 270 from conference room X's location schedule, and reserve conference room X for the user that has the event with the “A” priority (see FIG. 5 and corresponding text for further details regarding scheduling prioritized events). When the user wishes to send the reservation request to the scheduling tool, the user selects command button 240. If the user wishes to cancel the event request, the user selects command button 250 to close window 200.

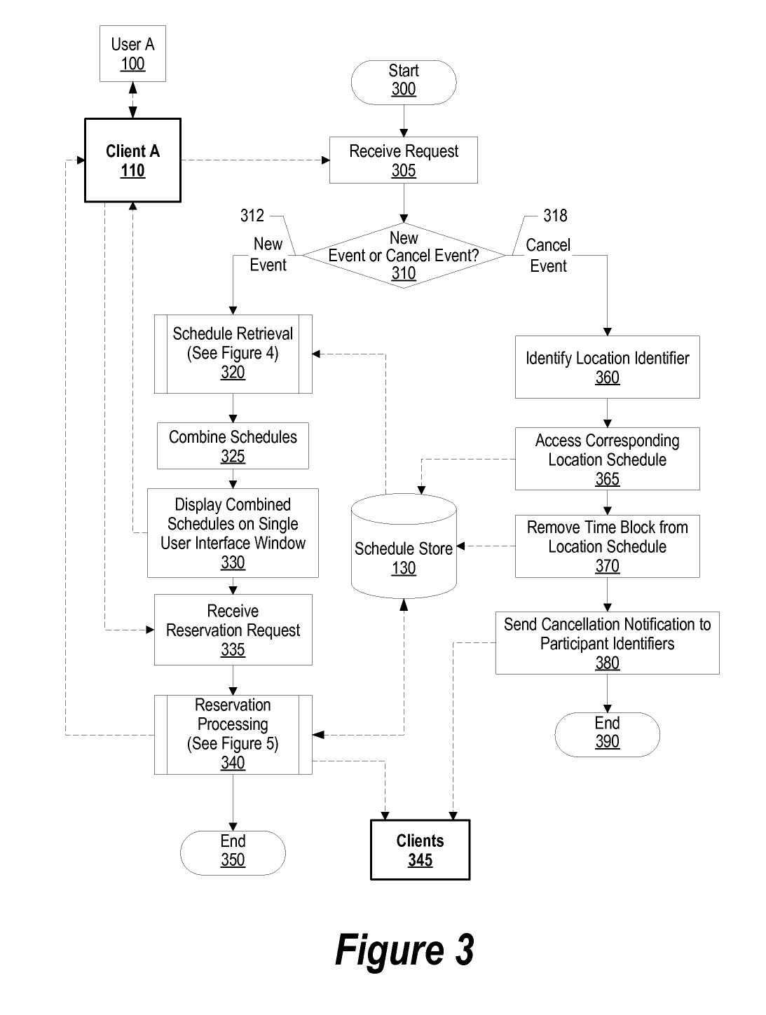

FIG. 3 is high-level flowchart showing steps taken in scheduling or canceling an event. A user wishes to schedule an event, such as a meeting, and uses a scheduling tool to view participant schedules, location schedules, and equipment schedules in a single user interface window. The participant schedules correspond to participants that are invited to the event. The location schedule corresponds to a location for the event, such as a conference room, and the equipment schedules correspond to equipment such as a projector, a television, a printable white board, or a computer.

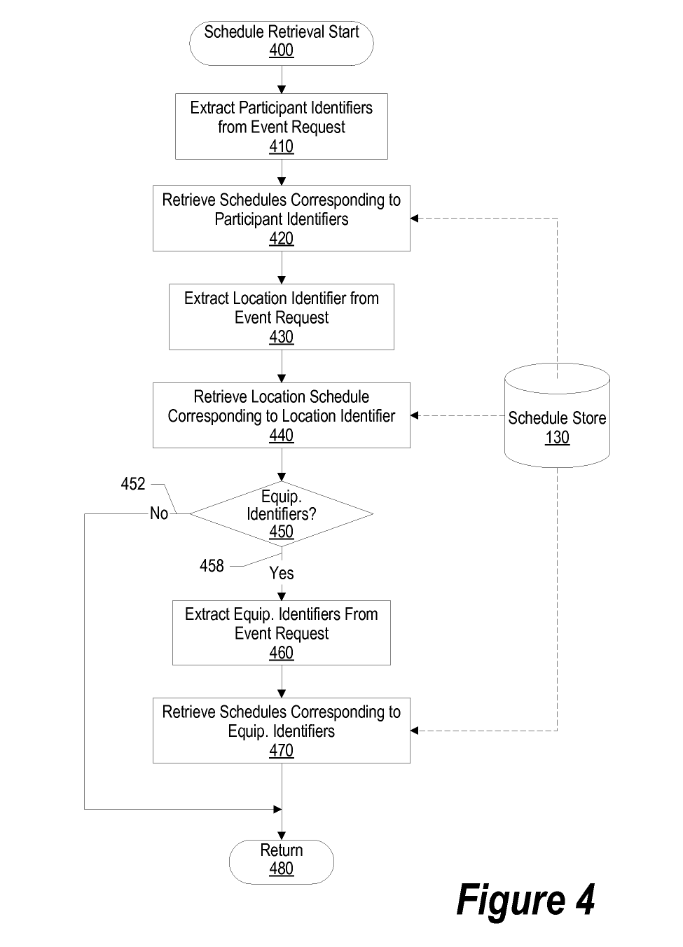

Processing commences at 300, whereupon processing receives a request from user A 100 through client A 110 at step 305. User A 100 and client A 110 are the same as that shown in FIG. 1. A determination is made as to whether user A 100 wishes to schedule a new event or cancel a reserved event (decision 310). If user A 100's request is to schedule a new event, decision 310 branches to “New Event” branch 312, whereupon processing retrieves schedules that correspond to participants, a location, and equipment from schedule store 130 (pre-defined process block 320, see FIG. 4 and corresponding text for further details). Schedule store 130 is the same as that shown in FIG. 1.

A step 325, processing combines the retrieved schedules into a single user interface window and, at step 330, processing displays the combined schedules on client A 110 for user A 100 to view, such as user interface windows 200 or 260 that are shown in FIGS. 2A and 2B, respectively. In one embodiment, processing provides the schedules to client A 110, and client A 110 combines the schedules into a single user interface window for user 100 to view.

User A 100 reviews the combined schedules in the single user interface window, and sends a reservation request that includes an event time for the event, which processing receives at step 335. Processing accesses schedule store 130 and reserves the location, reserves the equipment, sends a confirmation to client A 110, and sends notifications to clients 345 (pre-defined process block 340, see FIG. 5 and corresponding text for further details). Clients 345 correspond to participants that are invited to the event, such as participant B 145 and participant C 155 that are shown in FIG. 1. Processing ends at 350.

If user A 100's request is a request to cancel a reserved event, decision 310 branches to “Cancel Event” branch 318, whereupon processing identifies a location identifier that corresponds to the reserved event at step 360. For example, user A 100 may have a meeting scheduled to occur at conference room XYZ and, in this example location identifier “confroomXYZ” and a corresponding event time may be included in the cancel event request that was received from client A 110.

At step 365, processing accesses a location schedule that corresponds to the retrieved location identifier from schedule store 130 and, at step 370, processing removes a reserved time block from the location schedule that corresponds to the reserved event that user 100 wishes to cancel, thus freeing up the location for other users to reserve. In one embodiment, when equipment is reserved for the event, processing accesses the equipment's corresponding schedules and removes the time blocks from their schedules as well, freeing the equipment to be reserved by other users.

Processing sends cancellation notifications to clients 345 at step 380, informing their corresponding participants that the event has been cancelled. Processing ends at 390.

FIG. 4 is a flowchart showing steps taken in retrieving schedules that correspond to participants, a location, and equipment. A scheduling tool received an event request from a user that wishes to schedule an event, such as a meeting. The event request includes one or more participant identifiers that correspond to invitees as well as a location identifier that corresponds to an event location, such as a conference room (see FIG. 3 and corresponding text for further details regarding receiving an event request).

Processing commences at 400, whereupon processing extracts one or more participant identifiers from the event request (step 410). For example, the participant identifiers may correspond to participant B 145 and participant C 155 that are shown in FIG. 1. At step 420, processing retrieves participant schedules that correspond to the participant identifiers from schedule store 130. Using the example described above, processing retrieves participant B schedule 140 and participant C schedule 150 (shown in FIG. 1) from schedule store 130. Schedule store 130 is the same as that shown in FIG. 1, and may be stored on a nonvolatile storage area, such as a computer hard drive.

Processing extracts the location identifier from the event request at step 430, and retrieves a location schedule corresponding to the location identifier from schedule store 130 (step 440). For example, the location identifier may correspond to conference room X 165 shown in FIG. 1 and, in this example, processing retrieves conference room X schedule 160 (also shown in FIG. 1) from schedule store 130.

A determination is made as to whether the event request includes equipment identifiers (decision 450). For example, the user may wish to reserve a printable white board for the meeting. If the event request does not include equipment identifiers, decision 450 branches to “No” branch 452 bypassing equipment identifier processing steps. On the other hand, if the event request includes equipment identifiers, decision 450 branches to “Yes” branch 458 whereupon processing extracts the equipment identifiers from the event request at step 460, and retrieves corresponding equipment schedules from schedule store 130 (step 470). For example, the event request may include an equipment identifier that corresponds to equipment Y 175 shown in FIG. 1 and, in this example, processing retrieves equipment Y schedule 170 (also shown in FIG. 1) from schedule store 130. Processing returns at 480.

FIG. 5 is a flowchart showing steps taken in reserving a location and sending invitations to participants for an event. A scheduling tool provided schedules corresponding to an event request in a single user interface window to a user. In turn, the user identified an event time and sent a reservation request to the scheduling tool to reserve the event for the identified event time (see FIG. 3 and corresponding text for further details regarding receiving a reservation request).

Processing commences at 500, whereupon processing extracts a location identifier and an event time from the reservation request at step 505. At step 510, processing retrieves a location schedule that corresponds to the location identifier from schedule store 130. Schedule store 130 is the same as that shown in FIG. 1.

A determination is made as to whether a schedule conflict exists between the extracted event time and a reserved time block included in the retrieved location schedule. (decision 520). For example, the event time may be from 2 pm-4 pm on Jan. 31, 2005 and, in this example, the location schedule includes a reserved time block from 1 pm-3 pm, making the location unavailable during the requested event time. In one embodiment, locations are assigned corresponding email addresses, which are used as location identifiers. In turn, processing may act as a “proxy” for the locations and automatically respond to a request according to a standard default policy it retrieves from a storage area. For example, processing may allow a vice-president or his/her assistant to bump anyone from his/her particular conference room schedule in order for the vice-president to use the conference room. If there is not a schedule conflict, decision 520 branches to “No” branch 522 bypassing schedule resolution steps.

On the other hand, if there is a schedule conflict, processing branches to “Yes” branch 528 whereupon processing identifies a priority that corresponds to the reserved time block at step 530. For example, a user may have scheduled a weekly team meeting at a particular time, which has an assigned priority of “C.”

A determination is made as to whether a new time block priority corresponding to the requested event time is greater than the reserved time block priority (decision 540). For example, the new event request may correspond to a customer meeting that requires the facilities that are only available in the requested conference room. If the new time block priority is not greater than the reserved time block priority, decision 540 branches to “No” branch 542 whereupon processing sends a notification to client A 110, which notifies the user who generated the reservation request that their reservation request is not approved (step 550). Client A 110 is the same as that shown in FIG. 1. Processing returns at 555.

On the other hand, if the new time block priority is greater than the reserved time block priority, decision 540 branches to “Yes” branch 548 whereupon processing removes the reserved time block from the location schedule (step 560), and notifies the originator of the event corresponding to the reserved time block that the location that they originally reserved has been reserved by another user. In one embodiment, processing may search other location schedules that are included in schedule store 130 and provide the originator with alternative locations that are in proximity to the original location. In this embodiment, the scheduling tool may also identify the number of invitees to the event and select locations that are able to accommodate the number of invitees.

At step 580, processing inserts a new time block into the location schedule. The new time block corresponds to the event time that is included in the reservation request that was received by the scheduling tool. Processing sends a confirmation to client A 110, which notifies the user that generated the reservation request that the location has been successfully reserved (step 590). At step 595, processing sends invitations to clients 345, which correspond to participant identifiers that are included in the reservation request. Client A 110 and clients 345 are the same as that shown in FIGS. 1 and 3, respectively. When a reservation request includes one or more equipment identifiers, processing reserves the corresponding equipment in a manner similar to how it reserves a location. Processing returns at 599.

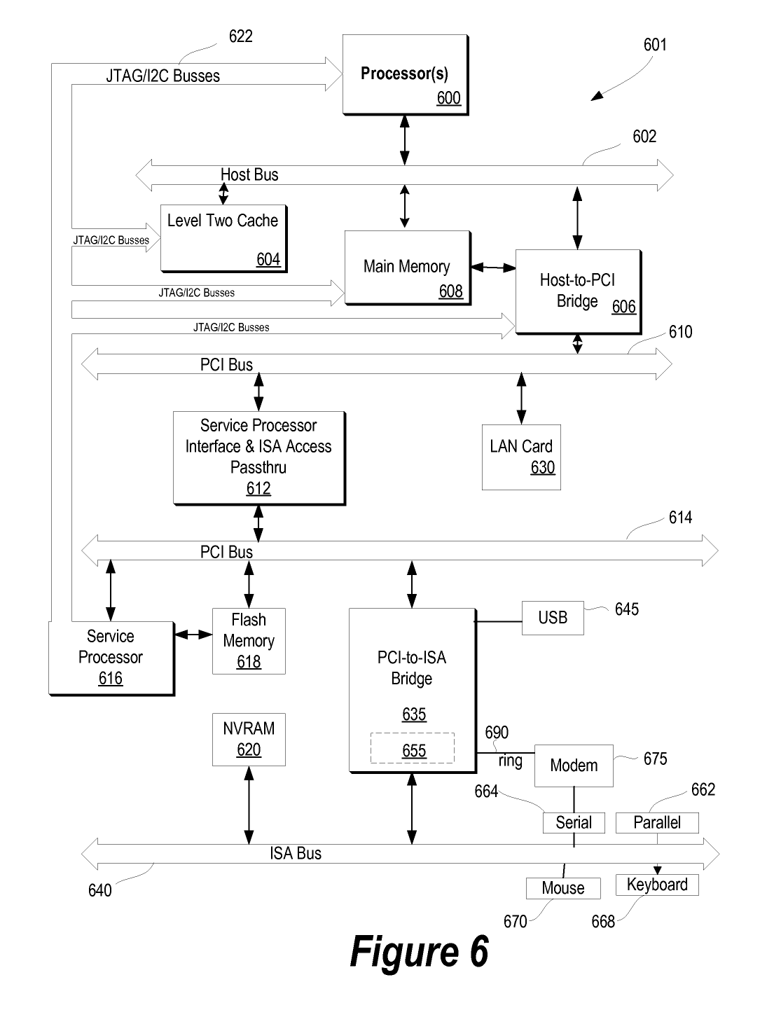

FIG. 6 illustrates information handling system 601 which is a simplified example of a computer system capable of performing the computing operations described herein. Computer system 601 includes processor 600 which is coupled to host bus 602. A level two (L2) cache memory 604 is also coupled to host bus 602. Host-to-PCI bridge 606 is coupled to main memory 608, includes cache memory and main memory control functions, and provides bus control to handle transfers among PCI bus 610, processor 600, L2 cache 604, main memory 608, and host bus 602. Main memory 608 is coupled to Host-to-PCI bridge 606 as well as host bus 602. Devices used solely by host processor(s) 600, such as LAN card 630, are coupled to PCI bus 610. Service Processor Interface and ISA Access Pass-through 612 provides an interface between PCI bus 610 and PCI bus 614. In this manner, PCI bus 614 is insulated from PCI bus 610. Devices, such as flash memory 618, are coupled to PCI bus 614. In one implementation, flash memory 618 includes BIOS code that incorporates the necessary processor executable code for a variety of low-level system functions and system boot functions.

PCI bus 614 provides an interface for a variety of devices that are shared by host processor(s) 600 and Service Processor 616 including, for example, flash memory 618. PCI-to-ISA bridge 635 provides bus control to handle transfers between PCI bus 614 and ISA bus 640, universal serial bus (USB) functionality 645, power management functionality 655, and can include other functional elements not shown, such as a real-time clock (RTC), DMA control, interrupt support, and system management bus support. Nonvolatile RAM 620 is attached to ISA Bus 640. Service Processor 616 includes JTAG and I2C busses 622 for communication with processor(s) 600 during initialization steps. JTAG/I2C busses 622 are also coupled to L2 cache 604, Host-to-PCI bridge 606, and main memory 608 providing a communications path between the processor, the Service Processor, the L2 cache, the Host-to-PCI bridge, and the main memory. Service Processor 616 also has access to system power resources for powering down information handling device 601.

Peripheral devices and input/output (I/O) devices can be attached to various interfaces (e.g., parallel interface 662, serial interface 664, keyboard interface 668, and mouse interface 670 coupled to ISA bus 640. Alternatively, many I/O devices can be accommodated by a super I/O controller (not shown) attached to ISA bus 640.

In order to attach computer system 601 to another computer system to copy files over a network, LAN card 630 is coupled to PCI bus 610. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the processes described herein, this computer system is simply one example of a computer system. Those skilled in the art will appreciate that many other computer system designs are capable of performing the processes described herein.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
receiving an event request, the event request including one or more participant identifiers and a location identifier;
retrieving one or more participant schedules that correspond to the one or more participant identifiers;
retrieving a location schedule that corresponds to the location identifier; and
displaying the one or more participant schedules and the location schedule in a single user interface window.

2. The method of claim 1 further comprising:
receiving a reservation request that corresponds to the event request, the reservation request including an event time; and
inserting a new time block into the location schedule based upon the event time.

3. The method of claim 2 further comprising:
sending an event notification to each of the one or more participant identifiers in response to receiving the reservation request, the event notification including the location identifier and the event time.

4. The method of claim 2 further comprising:
detecting that a reserved time block is included in the location schedule that conflicts with the event time; and
determining that a new time block priority corresponding to the new time block is higher than a reserved time block priority that corresponds to the reserved time block.

5. The method of claim 2 further comprising:
receiving a cancel event request that corresponds to the new time block; and
removing the new time block from the location schedule in response to receiving the cancel event request.

6. The method of claim 2 wherein the displaying is performed prior to receiving the reservation request.

7. The method of claim 2 wherein the one or more participant identifiers are one or more corresponding participant email addresses and the location identifier is a corresponding location email address.

8. The method of claim 7 further comprising:
detecting that a reserved time block is included in the location schedule that conflicts with the event time;
retrieving a policy that corresponds to the location schedule in response to the detecting;
comparing the policy with the location email address; and
removing the reserved time block from the location schedule based upon the comparing.

9. The method of claim 7 wherein the reservation request is initiated by a user, the method further comprising:
retrieving a policy that corresponds to one of the participant email addresses;
comparing the policy with a user email address that corresponds to the user; and
inserting the new time block into the participant schedule corresponding to the one of the participant email addresses in response to the comparing.

10. The method of claim 1 wherein the event request includes an equipment identifier, the method further comprising:
retrieving an equipment schedule that corresponds to the equipment identifier; and
displaying the equipment schedule in the single user interface window with the one or more participant schedules and the location schedule.

11. The method of claim 10 wherein the equipment identifier is an email address.

12. A program product comprising:
computer operable medium having computer program code, the computer program code being effective to:
receive an event request, the event request including one or more participant identifiers and a location identifier;
retrieve one or more participant schedules that correspond to the one or more participant identifiers;
retrieve a location schedule that corresponds to the location identifier; and
display the one or more participant schedules and the location schedule in a single user interface window.

13. The program product of claim 12 wherein the computer program code is further effective to:
receive a reservation request that corresponds to the event request, the reservation request including an event time; and
insert a new time block into the location schedule based upon the event time.

14. The program product of claim 13 wherein the computer program code is further effective to:
detect that a reserved time block is included in the location schedule that conflicts with the event time; and
determine that a new time block priority corresponding to the new time block is higher than a reserved time block priority that corresponds to the reserved time block.

15. The program product of claim 13 wherein the computer program code is further effective to:
receive a cancel event request that corresponds to the new time block; and
remove the new time block from the location schedule in response to receiving the cancel event request.

16. The program product of claim 13 wherein the one or more participant identifiers are one or more corresponding participant email addresses and the location identifier is a corresponding location email address.

17. An information handling system comprising:
one or more processors;
a memory accessible by the processors;
one or more nonvolatile storage devices accessible by the processors;
and
a scheduling tool for scheduling an event, the scheduling tool comprising software code effective to:
receive an event request from a client computer, the event request including one or more participant identifiers and a location identifier;
retrieve one or more participant schedules that correspond to the one or more participant identifiers from one of the nonvolatile storage devices;
retrieve a location schedule that corresponds to the location identifier from one of the nonvolatile storage devices; and
display the one or more participant schedules and the location schedule in a single user interface window on the client computer.

18. The information handling system of claim 17 wherein the software code is further effective to:
receive a reservation request from the client computer that corresponds to the event request, the reservation request including an event time; and
insert a new time block into the location schedule that is located on one of the nonvolatile storage devices based upon the event time.

19. The information handling system of claim 18 wherein the software code is further effective to:
detect that a reserved time block is included in the location schedule located in one of the nonvolatile storage devices that conflicts with the event time; and
determine that a new time block priority corresponding to the new time block is higher than a reserved time block priority that corresponds to the reserved time block.

20. The information handling system of claim 17 wherein the one or more participant identifiers are one or more corresponding participant email addresses and the location identifier is a corresponding location email address.
